(19) United States
(12) Patent Application Publication
(10) Pub. No.: US 2001/0037194 A1
(43) Pub. Date: Nov. 1, 2001

(54) Audio signal processing device

(76) Inventors: Ronaldus Maria Aarts, Eindhoven (NL); Robertus Theodorus Johannes Toonen Dekkers, Waalre (NL); Gerardus Cornelis Petrus Lokhoff, Eindhoven (NL)

Correspondence Address: Corporate Patent Counsel, U. S. Philips Corporation, 580 White Plains Road, Tarrytown, NY, 10591, US

(21) Appl. No.: 09/741,917

(22) Filed: Dec. 20, 2000

(30) Foreign Application Priority Data
Dec. 24, 1999 (EP) 99204543.5

(51) Int. Cl. G06F 15/00

(52) U.S. Cl. 704/200

(57) ABSTRACT

An audio signal processing device comprises signal supply means to supply speech and music signals via one or more input channels.

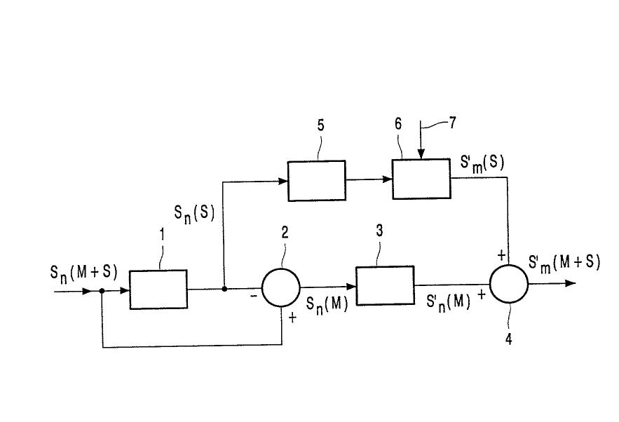

The device further comprises separating means to separate the speech and music signals. First converter means are used to convert the music signals into a required virtual widening from one or more input channels. Combination means are used to combine the speech signals with the converted music signals.

The invention relates to an audio signal processing device for speech and music signals.

Although the speech and sound signals come from a certain direction defined by an arrangement of loudspeakers, there is nevertheless a demand that speech and music signals should seem to come from different directions, as perceived by listeners.

To achieve this object, the audio signal processing device according to the invention is provided with signal supply means for supplying speech and music signals over one or several (n) different input channels, separation means for substantially separating the speech and music signals, first converter means for converting the music signals in accordance with a desired virtual spatial widening from which the music signals can be heard through one or several (m) different output channels, and combination means for combining the speech signals with the converted music signals.

It is true for the case in which n=2 and m=2, i.e. for conventional stereo sound reproduction, for example with the use of headphones, that music can be heard with a virtual spatial spread through the use of an audio signal processing device according to the invention, and speech can be equally distributed over the two channels (left and light) as a mono signal, or can be heard through one of the two channels (left or right). The music heard in a wider spatial virtual spread is referred to hereinafter as “widened” music for short. The device according to the invention renders it possible, accordingly, to widen music but not speech, and can be effective both for speech and music signals separately and for the simultaneous reproduction of speech and music.

Since it may be desirable in certain circumstances to have the speech appear from any other direction desired, it is possible furthermore according to the invention that signal direction detection means are present for ascertaining the direction from which the speech signals originate, and second converter means for converting the speech signals in accordance with a desired virtual change in the direction from which the speech signals can be heard, the converted speech signals and the converted music signals being joined together in the combination means.

This measure renders it possible, for example, that speech is still being heard through headphones from the direction of a speaker, whether the latter is stationary or is walking to and from or even if several speakers are present who address an auditorium consecutively from different spatial angles. The measures according to the invention may also be important for videoconferencing, where the speech can also be made to originate from the direction of the speaker on a displayed video picture and not from the direction from which image and sound were recorded. It may be especially unpleasant and adversely affect the ease of understanding of speech when the perceived directions of image and sound do not coincide.

The second converter means mentioned above may be provided with one or several additional input channels through which speech and position signals can be supplied from a microphone having position recording means. Speech signals from a further speaker can be put in this manner and be reproduced as though coming from the direction of this speaker.

The invention further relates to an audio reproduction system provided with an audio signal processing device as described above, and with sound reproduction means for the separate output channels for rendering amplified speech and music signals audible.

The invention also relates to an audiovisual reproduction system provided with an audio signal processing device as described above and to a unit in which a picture screen and sound reproduction means are incorporated.

The invention will now be explained in more detail below with reference to the accompanying drawing, which is a block diagram representing the functions of the audio signal processing device according to the invention.

The FIGURE shown in the drawing shows a speech filter 1 in which the n input signals Sₙ(M+S) are filtered, the speech signals Sₙ(S) only being present at the output. The music signals Sₙ(M) are obtained from the input signals and the speech signals by differentiating means 2. In practice, the speech filter and the differentiating means together form separating means for substantially separating the speech signals from the music signals. Such separating means are known per se from Karaoke techniques and are based on the effect, for example, that speech is present in a certain frequency band or is distributed over the input channels with a fixed weighting or a weighting which changes with the movement of speakers.

The music signals Sₙ(M) are converted to so-called widened music signals Sₘ′(M) in (first) converter means 3 in accordance with a desired virtual spatial widening from which the music signals can be heard through the individual channels. The number of input channels n obviously need not be equal to the number of output channels m. Such music widening techniques are also known per se, for example from U.S. Pat. No. 5,742,687. Finally, the speech signals Sₙ(S) can be combined again with the widened music signals by combination means 4. The music signals are widened in this manner, whereas the speech signals are perceived as coming from the original direction. If two channels are present, and music and speech are amplified and reproduced through two loudspeakers L (left) and R (right), it can be achieved with this system that the music is perceived as coming from two virtual loudspeakers, while the speech is perceived as coming from both or one of the two loudspeakers.

Since it may be desirable that also the speech signals can be perceived as coming from an adjustable direction, the audio signal processing device shown in the FIGURE is in addition provided with signal direction detection means 5 and second converter means 6. The direction from which the speech signals originate is ascertained in the signal direction detection means, for example through the use of known PCA (principal component analysis) techniques. The speech signals are converted to speech signals Sₘ′(S) in the converter means 6 in accordance with a desired virtual change in the direction from which the speech signals can be heard. The signals are subjected to a matrix multiplication in a known manner, the matrix coefficients for the desired virtual channels being determined by calibration, so as to achieve that the signals transmitted through real channels are perceived as coming through virtual channels. If two channels are present, and speech is transmitted in amplified form through two loudspeakers L (left) and R (right), for example both equally strongly, such a matrix multiplication achieves that a stronger signal is perceived as coming from the one loudspeaker than from the other loudspeaker, which means that the speech is perceived as coming from a different (virtual) direction, defined by the matrix coefficients, as compared with the original direction defined by the loudspeakers.

The second converter means 6 mentioned above may in addition be provided with one or several additional input channels 7 through which speech and position signals can be supplied from a microphone which has position detection means. Speech signals from a further speaker can thus be put in and reproduced as if they were coming from the direction of this speaker.

The converted speech and music signals may be joined together again by the combination means 4 into signals Sₘ′(M+S). The music signals are thus widened, while the speech signals are perceived as coming from a direction which may be adjusted. If two channels are present, and music and speech are transmitted in amplified form through two loudspeakers L (left) and R (right), it is possible by means of this system to achieve that the music is perceived as coming from two virtual loudspeakers, whereas the speech is perceived as coming from a certain, selected direction.

It will be obvious that the invention is not limited to applications in which only two input and output channels are present. Any number of input and output channels desired in practice is possible. Thus a monosignal S₁(M+S) may be supplied to the audio processing device through an input channel, and a specific speech signal through the additional input channel, while the output signal is reproduced in mono or in stereo, for example in the case of videoconferencing. Such a situation is comparable to that in which signals S₂(M+S) are supplied to the audio signal processing device through two separate input channels.

1. An audio signal processing device provided with signal supply means for supplying speech and music signals over one or several (n) different input channels, separation means for substantially separating the speech and music signals, first converter means for converting the music signals in accordance with a desired virtual spatial widening from which the music signals can be heard through one or several (m) different output channels, and combination means for combining the speech signals with the converted music signals.

2. An audio signal processing device as claimed in claim 1, characterized in that signal direction detection means are present for ascertaining the direction from which the speech signals originate, and second converter means for converting the speech signals in accordance with a desired virtual change in the direction from which the speech signals can be heard, the converted speech signals and the converted music signals being joined together in the combination means.

3. An audio signal processing device as claimed in claim 2, characterized in that the second converter means are provided with one or several additional input channels through which speech and position signals can be supplied from a microphone having position recording means.

4. An audio reproduction system provided with an audio signal processing device as claimed in claim 1, 2, or 3 and with sound reproduction means for the individual output channels for reproducing amplified speech and music signals.

5. An audiovisual reproduction system provided with an audio signal processing device as claimed in claim 1, 2 or 3, and with a unit in which a picture screen and sound reproduction means are incorporated.
